(19) United States
(12) Patent Application Publication
(10) Pub. No.: US 2008/0119350 A1
(43) Pub. Date: May 22, 2008

(54) ION EXCHANGE TYPE LITHIUM ADSORBENT USING FILTER AND METHOD FOR PREPARING THE SAME

(75) Inventors: Kang-Sup CHUNG, Daejon (KR); Jae-Chun LEE, Daejon (KR); Yong-Jae SUH, Daejon (KR); Dae-Sup KIL, Daejon (KR); Hwan LEE, Daejon (KR)

Correspondence Address: LOWE HAUPTMAN HAM & BERNER, LLP, 1700 DIAGONAL ROAD, SUITE 300, ALEXANDRIA, VA, 22314, US

(73) Assignee: Korea Institute of Geosciences and Mineral Resources, Daejon (KR)

(21) Appl. No.: 11/942,882

(22) Filed: Nov. 20, 2007

(30) Foreign Application Priority Data
Nov. 20, 2006 (KR) 10-2006-0114344
Nov. 20, 2006 (KR) 10-2006-0114345
Nov. 16, 2007 (KR) 10-2007-0117012

(51) Int. Cl. B01J 20/28

(52) U.S. Cl. 502/4; 502/104

(57) ABSTRACT

There is provided a method for preparing an ion exchange type lithium adsorbent using a filter including: synthesizing precursor powder as lithium manganese oxide having a spinel structure; filling the precursor powder in the filter; and acid-treating the filter filled with the precursor powder.

### CROSS-REFERENCE(S) TO RELATED APPLICATIONS

The present invention claims priority of Korean Patent Application Nos. 10-2006-0114344, 10-2006-0114345 and 10-2007-0117012 filed on Nov. 20, 2006, Nov. 20, 2006 and Nov. 16, 2007, respectively, which are incorporated herein by reference.

### BACKGROUND OF THE INVENTION

1. Field of the Invention

The present invention relates to an ion exchange type lithium adsorbent using a filter and a method for preparing the same; and, more particularly, to a method for preparing an adsorbent capable of selectively adsorbing and collecting lithium only from an aqueous solution in which lithium is dissolved, by filling ion exchange type lithium manganese oxide powder in a filter and acid treating the powder, and an ion exchange lithium adsorbent using a filter.

2. Description of Related Art

In recent times, lithium and lithium compounds have been used in various fields such as a secondary battery material, a refrigerant adsorbent, catalysts, medicines, and so on, and are important resources come into the spotlight as nuclear fusion energy source. In addition, demand of lithium and lithium compounds will be increased in technology fields such as a large capacity battery, an electric automobile, and so on, which are to be in practical use.

While importance of lithium applicable to various fields has been increased, lithium reserves in the world are merely two to nine million tons. In order to overcome the insufficient lithium reserves, researches on technology for obtaining lithium resources through various ways have been performed. Recently, researches for effectively collecting a very small amount of lithium dissolved in aqueous solution such as seawater, salt water, lithium battery waste solution, and so on, has been performed.

A conventional lithium collecting method includes a method of deoxidizing lithium ions using an electrochemical method, or a method of deoxidizing lithium oxide using magnesium or aluminum metal. Another method of collecting lithium using adsorbent for selectively adsorbing lithium ion has been researched. Major purpose of these researches using lithium adsorbent is to develop high performance adsorbent having high selectivity and good adsorption/desorption performance.

As a result of these researches, a method of preparing powder for readily adsorbing/desorbing lithium through a solid reaction method or a gel method using manganese oxide. Powder manufactured through the methods has been used as a secondary lithium battery positive pole material, a lithium adsorbent material, and so on. However, since use of lithium adsorbent powder cause troublesome handling thereof, it is needed to mold the lithium adsorbent powder and then use it. For example, as disclosed in Korean Patent Laid-open Publication 2003-9509, a method consisting of mixing the powder with alumina powder, and then conglomerating the mixture using a porosity-forming agent such as polyvinyl chloride (PVC) may be performed to form a bead shape of adsorbent.

However, when the conventional PVC addition method is used to form the bead shape of adsorbent, since adsorption space for adsorbing/desorbing lithium is reduced by about 30% or more in comparison with the adsorbent powder even though its handling is convenient, lithium collecting performance may be decreased when the bead shape of adsorbent is used as the lithium adsorbent.

In order to overcome the problems, the inventors have invented adsorbent using urethane foam and honeycomb-shaped adsorbent (Korean Patent Registration Nos. 557824 and 536957). As a result of overcoming disadvantages of the lithium adsorbent powder, it is possible to obtain lithium adsorbent that can be readily handled, selectively adsorb lithium ion only, and provide good lithium adsorption capacity.

However, even though the adsorbent is used, adsorption efficiency may be somewhat decreased in comparison with the adsorbent powder. Therefore, there is still needed a novel type lithium adsorbent capable of preventing decrease in adsorption efficiency in comparison with the lithium adsorbent powder, selectively adsorbing lithium only with good performance, and readily performing a desorption process for collecting lithium after adsorption.

### SUMMARY OF THE INVENTION

It is an aspect of the present invention is to provide an ion exchange type lithium adsorbent using a filter capable of providing physical and chemical stability, facilitating handling, selectively adsorbing lithium ion only, increasing adsorption capacity, and effectively adsorbing and collecting lithium.

It is another aspect of the present invention is to provide a method for readily and conveniently fabricating an ion exchange type lithium adsorbent using a filter having good lithium adsorption capacity, stability, and easy handling.

An embodiment of the present invention is directed to a method for preparing an ion exchange type lithium adsorbent using a filter including: synthesizing precursor powder as lithium manganese oxide having a spinel structure; filling the precursor powder in the filter; and acid-treating the filter filled with the precursor powder.

An embodiment of the present invention is directed to a method for preparing an ion exchange type lithium adsorbent using a filter including: synthesizing precursor powder as lithium manganese oxide having a spinel structure and the following chemical formula 1

LiₙMn₂₋ₓO₄, wherein 1≦n≦1.33, 0≦n≦0.33, and n≦1+x; [Chemical Formula 1]

filling the precursor powder in the filter; and acid-treating the filter filled with the precursor powder.

Still another embodiment of the present invention is directed to an ion exchange type lithium adsorbent using a filter formed of ion exchange type manganese oxide having a spinel structure filled therein.

Yet another embodiment of the present invention is directed to an ion exchange type lithium adsorbent using a filter formed of ion exchange type manganese oxide having a spinel structure and the following chemical formula 1a

HₙMn₂₋ₓO₄, wherein 1≦n≦1.33, 0≦n≦0.33, and n≦1+x, filled therein. [Chemical Formula 1a]

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

### BRIEF DESCRIPTION OF THE DRAWINGS

FIG. 1 is a scanning electron microscope photograph of an ion exchange type lithium adsorbent using an ultra filtration filter obtained by a first exemplary embodiment of the present invention;

FIG. 2 is a scanning electron microscope photograph of an ion exchange type lithium adsorbent using an ultra filtration filter obtained by a second exemplary embodiment of the present invention;

FIG. 3 is a photograph of an ion exchange type lithium adsorbent using a ceramic filter obtained by a third exemplary embodiment of the present invention;

FIG. 4 is a photograph of an ion exchange type lithium adsorbent using a ceramic filter obtained by a fourth exemplary embodiment of the present invention;

FIG. 5 is a scanning electron microscope photograph of an ion exchange type lithium adsorbent using a ceramic filter obtained by a third exemplary embodiment of the present invention;

FIG. 6 is a scanning electron microscope photograph of an ion exchange type lithium adsorbent using a ceramic filter obtained by a fourth exemplary embodiment of the present invention;

FIG. 7 is a photograph of an ion exchange type lithium adsorbent using a narrow fabric filter obtained by fifth and sixth embodiments of the present invention; and

FIG. 8 is a scanning electron microscope photograph of an ion exchange type lithium adsorbent using a narrow fabric filter obtained by a fifth embodiment of the present invention.

FIG. 9 is a scanning electron microscope photograph of an ion exchange type lithium adsorbent using a narrow fabric filter obtained by a sixth embodiments of the present invention.

### DESCRIPTION OF SPECIFIC EMBODIMENTS

The advantages, features and aspects of the invention will become apparent from the following description of the embodiments with reference to the accompanying drawings, which is set forth hereinafter. In addition, in description of the present invention, when specific description of conventional arts related to the present invention may cause misunderstanding of the present invention, detailed description will be omitted. Hereinafter, the present invention will be described with reference to the accompanying drawings.

Generally, lithium adsorbent must maintain physical and chemical stability in aqueous solution of various conditions and environments, and provide an adsorption space for securing high adsorption efficiency. In addition, high selectivity of the lithium ion should be maintained to prevent adsorption of elements except the lithium ion, and a desorption process for collecting lithium after adsorption should be readily performed.

In this respect, it will be appreciated that conventional lithium manganese oxide having a spinel structure as a precursor is acid-treated to phase dissolve lithium ions in compounds such that obtained resultant material represents excellent selectivity with respect to the lithium ions in subjective solution.

The lithium manganese oxide having a spinel structure applicable to the present invention can be applied without any limitation, under the condition that the lithium manganese oxide can be used as lithium adsorbent through ion exchange. More preferably, in consideration of requisite characteristics required for lithium adsorbent, lithium manganese oxide powder of the following chemical formula 1 having a spinel structure among the lithium manganese oxide having the spinel structure, known as to have selective adsorption capacity with respect to the lithium ion, can be used as a precursor.

LiₙMn₂₋ₓO₄, wherein 1≦n≦1.33, 0≦n≦0.33, and n≦1+x [Chemical Formula 1]

The lithium manganese oxide powder of the chemical formula 1 has high chemical stability. When the powder is formed as an ion sieve, since selective adsorption capacity of a lithium ion can be showed, it is possible to be applied to the present invention as a precursor of lithium adsorbent.

While the present invention is not limited to the lithium manganese oxide of the chemical formula 1, lithium manganese oxide of the following chemical formula 2 may be used as ion exchange precursor powder:

Li_{1.33}Mn_{1.67}O₄. [Chemical Formula 2]

Lithium adsorption efficiency can be maximized when the ion exchange type precursor powder of the chemical formula 2 is used as lithium adsorbent to enable easy handling and readily perform a desorption process of collecting a lithium ion after adsorption.

Since the ion exchange type precursor powder of the chemical formula 2 can adsorb and desorb through an ion exchange method like the following reaction formula 1:

(Li)[Li_{0.33}Mn(IV)_{1.67}]O₄ [symbol] (H)[H_{0.33}Mn(IV)_{1.67}]O₄ [Reaction formula 1]

wherein ( ) represents 8a tetrahedron digits in a spinel structure, and [ ] represents 16d octahedron digits in a spinel structure, it can be used in the ion exchange type lithium adsorbent using a filter in accordance with the present invention.

In addition, an example of the ion exchange type lithium manganese appropriately applicable to the present invention may be lithium manganese oxide of the following chemical formula 3:

Li_{1.6}Mn_{1.6}O₄. [Chemical Formula 3]

It was known that the lithium manganese oxide of the chemical formula 3 has good selective adsorption efficiency with respect to a lithium ion.

The ion exchange type lithium manganese oxide precursor powder may be prepared according to methods known in the art, for example, a solid-state reaction method or a gel method. The solid-state reaction method, which is also referred to as a high-temperature solid-state reaction method, is performed by mixing lithium compound with manganese compound and heat-treating at a high temperature to form lithium manganese oxide powder. The gel method is performed by mixing lithium compound with manganese compound in an appropriate solvent, adding tartaric acid solution or citric acid solution to form gel, and drying the gel to form lithium manganese oxide powder.

Since the methods for preparing ion exchange type lithium manganese oxide precursor powder are already known, the present invention may select and use an appropriate method according to desired properties or manufacturing conditions.

In the present invention, adsorbent is prepared by filling the ion exchange type precursor powder in a filter, and acid treating the filter filled with the precursor powder to form an ion sieve.

While the filter used in the present invention may be applied without any limitation under the condition that the filter has good characteristics in solvent transmissivity, mechanical strength and chemical resistance, the filter may be any one filter selected from the group consisting of an ultra filtration filter, a ceramic filter, and a narrow fabric filter. The ultra filtration filter, the ceramic filter, and the narrow fabric filter must have physical and chemical durability against solvent in which the precursor powder is applied, and loss of the precursor powder filled in the filter to external solvent should be prevented. In addition, the filter may have high solvent transmissivity to allow the solvent to readily pass through the filter.

In addition, a pore size of the filter surface may be smaller than the size of the ion exchange type lithium manganese oxide precursor powder filled in the filter to prevent loss of the powder. Since the particle size of the precursor powder used in the present invention is generally about 10 μm, the filter having pores smaller than the particle size to be filled may be appropriately used in the present invention.

A hollow fiber membrane consisting of a hollow fiber, one of separation membranes, is widely used in various industries such as wastewater treatment, water treatment including water preparation, concentration of foods and medicine manufacturing, separation oxygen and nitrogen from air, collection of ammonia, and so on. The hollow fiber membrane has a larger surface area than other separation membranes to obtain high yield with a small capacity. The hollow fiber membrane is formed of a polymer plastic material to form a polymer body, which may use polysulfone, sulfonated polysulfone, polyethersulfone, cellulose acetate, cellulose nitrate, polyvinylidene fluoride, polyacrylonitril or mixture thereof, but not limited thereto.

The ultra filtration filter consists of the hollow fiber membrane formed of several thousands of hollow fiber, which are woven in a bundle shape. A pore size of the membrane surface is about 0.001 to 0.01 micron, which is used as a water purifier filter, and so on. The ultra filtration filter applicable to the present invention may be used without any limitation, under the condition that it is used as a separation membrane.

The ceramic filter is formed by firing porous ceramic particles at a high temperature. Since gaps between ceramic particles form pores, a pore size was known as several micrometers, minimum 0.2 μm. The ceramic filter is generally manufactured using porous ceramic materials such as alumina, silica, zirconia, titanium oxide, and so on. Since these materials have good heat resistance, chemical resistance, and so on, the ceramic filter is applicable to various purposes such as gas collecting, water purification, or the like.

While the ceramic filter applicable to the present invention may be used without any limitation, under the condition that it is used as a conventional solvent/solute separation filter, in consideration of the above characteristics, it is preferable to use a cylindrical ceramic filter having a pore size of 1-10 μm and formed of an alumina material. Since alumina has high heat resistance and good physical/chemical durability, the ceramic filter using alumina may be usefully employed.

The narrow fabric filter is a filter formed of a narrow fabric, which is formed of a fabric having a small width when the fabric is classified according to its width. The narrow fabric may be formed of polyester, nylon, polypropylene, acryl, cotton, and so on, but not limited thereto. The narrow fabric is generally woven by crossing warp and woof using a narrow fabric weaving machine through plane fabrics, double cloth, triple cloth, and so on, to form one of fabric filters using the structure. While the narrow fabric filter usable in the present invention may be applied without any limitation, under the condition that the filter is used as a conventional separation membrane, the narrow fabric filter having a fabric density formed of a pore size smaller than a particle size 10 μm of the precursor powder may be appropriately applied to the present invention.

In this respect, the narrow fabric filter appropriately usable in the present invention may be formed of narrow fabric woven in a plain fabric and prepared though a circular weaving machine using a high tension polyester warp (1500 denia, 192 pillar, and 144 pattern) and woof (1500 denia, 192 pillar, and 1 strip). In addition, in consideration of the particle size of the precursor powder, a fabric density may be about 20-25, preferably 21.5.

The present invention is characterized in that the precursor powder is filled in a filter used to separate solvent/solute, especially, the ultra filtration filter, the ceramic filter or the narrow fabric filter. A filling ratio of the precursor powder may be adjusted in an apparent density ratio range, and adsorption efficiency of adsorbent in accordance with the present invention is in proportion to the filling ratio.

After filling the ion exchange type precursor powder in the filter, acid treatment is performed. When the filter in which the ion exchange type precursor powder is filled is acid treated as described above, for example, a lithium ion is exchanged with a hydrogen ion by reaction of the reaction formula 1 to selectively adsorb/desorb lithium ions only dissolving in corresponding solvent like the ion sieve, thereby preparing lithium adsorbent capable of readily collecting lithium.

That is, the ion exchange type lithium manganese oxide precursor of the chemical formulae 1 to 3 filled in the filter by acid treatment is changed into the ion exchange type manganese oxide of the chemical formula 1a (HₙMn₂₋ₓO₄, wherein 1≦n≦1.33, 0≦n≦0.33, and n≦1+x), the ion exchange type manganese oxide of the chemical formula 2a (H_{1.33}Mn_{1.67}O₄), and the ion exchange type manganese oxide of the chemical formula 3a (H_{1.6}Mn_{1.6}O₄), and acted as the ion sieve to adsorb an lithium ion through the ion exchange method.

The acid treatment may be performed in acid solution of 0.3-1.0M three to five times, 22-26 hours each time. The acid solution usable in the acid treatment may be hydrochloric solution, but not limited thereto. In addition, in order to maximize generation of a lithium hole for more effective reversible reaction between a lithium ion and a hydrogen ion during the ion exchange reaction and prevent elution of a manganese ion, the acid treatment may be performed in hydrochloric solution of 0.5M during an acid treatment step four times, 24 hours each time.

The ion exchange type lithium adsorbent using a filter in accordance with the present invention is performed by filling ion exchange type precursor powder in a filter having good solvent transmissivity, mechanical strength and chemical resistance and acid treating the precursor powder to obtain physical and chemical stability, ready handling, and lithium adsorption capacity. In addition, the ion exchange type lithium adsorbent using a filter in accordance with the present invention can overcome disadvantages of adsorbent powder and remove or minimize reduction of an adsorbent space, thereby increasing selective adsorption efficiency of the lithium ion.

Hereinafter, the present invention will be described with reference to the following embodiments.

The following embodiments are described as an example of the present invention and should not be construed as to limit the present invention.

### Embodiment 1

### Preparation of Lithium Adsorbent Using Ultra Filtration Filter (1)

After inserting LiCO₃ and MnCO₃ into stirrers with a mol ratio 1.33:1.67 and sufficiently stirring and mixing them for 20 minutes, the mixture was heat-treated in an electric furnace at a temperature of 500° C. for four hours to synthesize Li_{1.33}Mn_{1.67}O₄ precursor powder.

After filling the synthesized precursor powder 1 g in the ultra filtration filter having an inner diameter 2 mm and a length 50 mm, the precursor powder was acid-treated in hydrochloric solution of 0.5M concentration four times, 24 hours each time to prepare the ion exchange type lithium adsorbent using an ultra filtration filter in accordance with the present invention.

### Embodiment 2

### Preparation of Lithium Adsorbent Using Ultra Filtration Filter (2)

First, CH₃COOLi and Mn(CH₃COO)₂.4H₂O were dissolved in ethanol, respectively. CH₃COOLi and Mn(CH₃COO)₂.4H₂O dissolved in ethanol were mixed with a mol ratio 1.33:1.67 and strongly stirred. Here, 0.1M tartaric acid solution dissolved in ethanol was gradually added to induce gel reaction to obtain deposit condensed with nano sizes. The obtained deposit was inserted into an oven at 70° C. and then slowly heated to be dried. The deposit was dried until ethanol component is perfectly removed to obtain light pink lithium manganese tartarate precursor. The precursor was re-heated at 200° C. for 6 hours to perfectly remove remaining moisture, and then, heat-treated at 500° C. for 24 hours to synthesize nano-sized Li_{1.33}Mn_{1.67}O₄ precursor powder.

The synthesized precursor powder 1 g is taken and inserted into the ultra filtration filter having a filter inner diameter 2 mm and a length 50 mm, and then, acid-treated in hydrochloric solution of 0.5M concentration four times, 24 hours each time, to prepare the ion exchange type lithium adsorbent using an ultra filtration filter in accordance with the present invention.

### Embodiment 3

### Preparation of Lithium Adsorbent Using Ceramic Filter (1)

After inserting LiCO₃ and MnCO₃ into stirrers with a mol ratio 1.33:1.67 and sufficiently stirring and mixing them for 20 minutes, the mixture was heat-treated in an electric furnace at a temperature of 500° C. for four hours to synthesize Li_{1.33}Mn_{1.67}O₄ precursor powder.

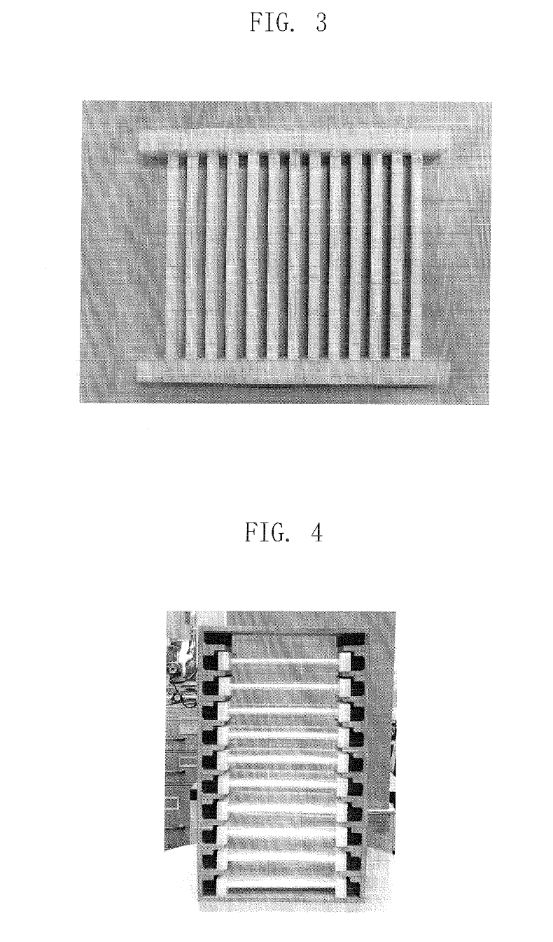

The synthesized precursor powder 10 g was taken and inserted into the ceramic filter having a pore size 5 μm, an outer diameter 10 mm, an inner diameter 7 mm and a length 230 mm. Then, as shown in FIGS. 3 and 4, after fixing a plurality of ceramic filters to a single frame, 10 stages of filters were mounted on a PVC drawer box, and then, the filters were acid-treated in hydrochloric solution of 0.5M concentration four times, 24 hours each time, thereby preparing the ion exchange type lithium adsorbent using a ceramic filter in accordance with the present invention.

### Embodiment 4

### Preparation of Lithium Adsorbent Using Ceramic Filter (2)

First, CH₃COOLi and Mn(CH₃COO)₂.4H₂O were dissolved in ethanol, respectively, to form solution. CH₃COOLi and Mn(CH₃COO)₂.4H₂O dissolved in ethanol were mixed with a mol ratio 1.33:1.67 and strongly stirred. Here, 0.1M tartaric acid solution dissolved in ethanol was gradually added to induce gel reaction to obtain deposit condensed with nano sizes. The obtained deposit was inserted into an oven at 70° C. and then slowly heated to be dried. The deposit was dried until ethanol component is perfectly removed to obtain light pink lithium manganese tartarate precursor. The precursor was re-heated at 200° C. for 6 hours to perfectly remove remaining moisture, and then, heat-treated at 500° C. for 24 hours to synthesize nano-sized Li_{1.33}Mn_{1.67}O₄ precursor powder.

The synthesized precursor powder 1 g is taken and inserted into the ceramic filter having a pore size 10 μm, an outer diameter 10 mm, a inner diameter 7 mm and a length 230 mm. As shown in FIGS. 3 and 4, after fixing a plurality of ceramic filters to a single frame and mounting the filters on a PVC drawer box in ten stages, the filters were acid-treated in hydrochloric solution of 0.5M concentration four times, 24 hours each time, to prepare the ion exchange type lithium adsorbent using a ceramic filter in accordance with the present invention.

### Embodiment 5

### Preparation of Lithium Adsorbent Using Narrow Fabric Filter (1)

After inserting LiCO₃ and MnCO₃ into stirrers with a mol ratio 1.33:1.67 and sufficiently stirring and mixing them for 20 minutes, the mixture was heat-treated in an electric furnace at a temperature of 500° C. for four hours to synthesize Li_{1.33}Mn_{1.67}O₄ precursor powder.

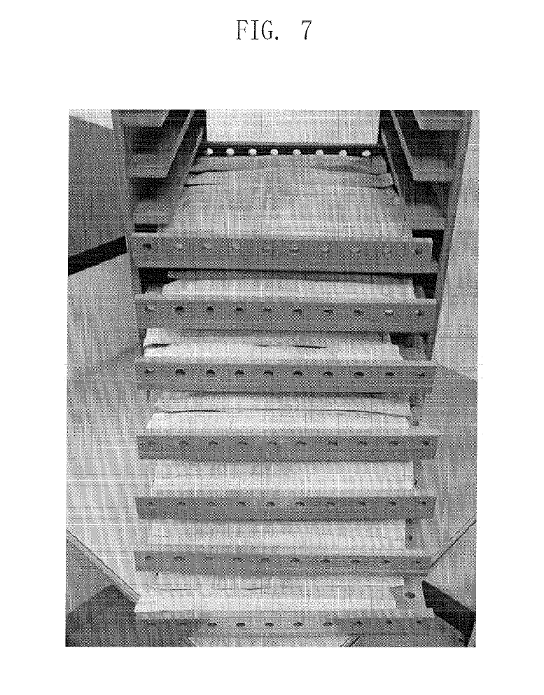

The synthesized precursor powder 30 g was taken and inserted into the narrow fabric filter having an outer diameter 30 mm and a length 300 mm. Then, as shown in FIG. 7, after fixing a plurality of narrow fabric filters to a single frame, 10 stages of filters were mounted on a PVC drawer box, and then, the filters were acid-treated in hydrochloric solution of 0.5M concentration four times, 24 hours each time, thereby preparing the ion exchange type lithium adsorbent using a narrow fabric filter in accordance with the present invention.

### Embodiment 6

### Preparation of Lithium Adsorbent Using Narrow Fabric Filter (2)

First, CH₃COOLi and Mn(CH₃COO)₂.4H₂O were dissolved in ethanol, respectively, to form solution. CH₃COOLi and Mn(CH₃COO)₂.4H₂O dissolved in ethanol were mixed with a mol ratio 1.33:1.67 and strongly stirred. Here, 0.1M tartaric acid solution dissolved in ethanol was gradually added to induce gel reaction to obtain deposit condensed with nano sizes. The obtained deposit was inserted into an oven at 70° C. and then slowly heated to be dried. The deposit was dried until ethanol component is perfectly removed to obtain light pink lithium manganese tartarate precursor. The precursor was re-heated at 200° C. for 6 hours to perfectly remove remaining moisture, and then, heat-treated at 500° C. for 24 hours to synthesize nano-sized Li_{1.33}Mn_{1.67}O₄ precursor powder.

The synthesized precursor powder 30 g was taken and inserted into the narrow fabric filter having an outer diameter 30 mm and a length 300 mm. Then, as shown in FIG. 7, after fixing a plurality of narrow fabric filters to a single frame, 10 stages of filters were mounted on a PVC drawer box, and then, the filters were acid-treated in hydrochloric solution of 0.5M concentration four times, 24 hours each time, thereby preparing the ion exchange type lithium adsorbent using a narrow fabric filter in accordance with the present invention.

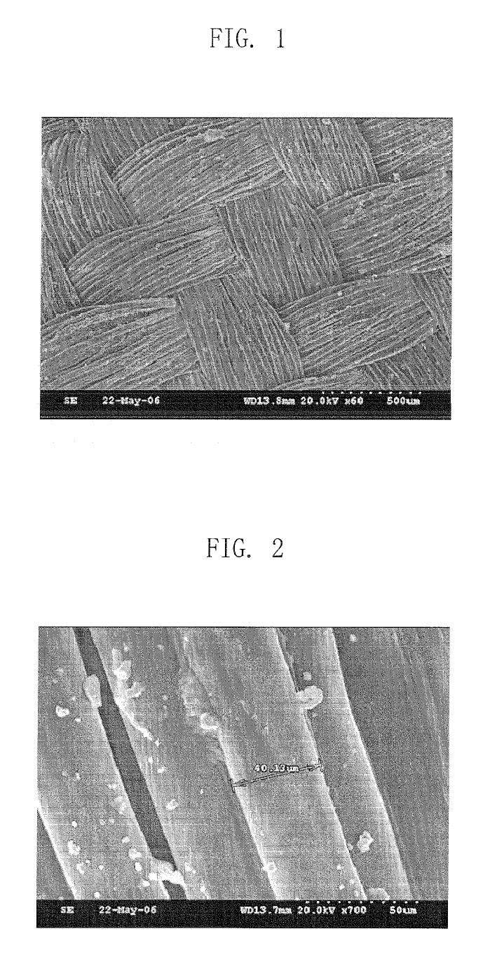

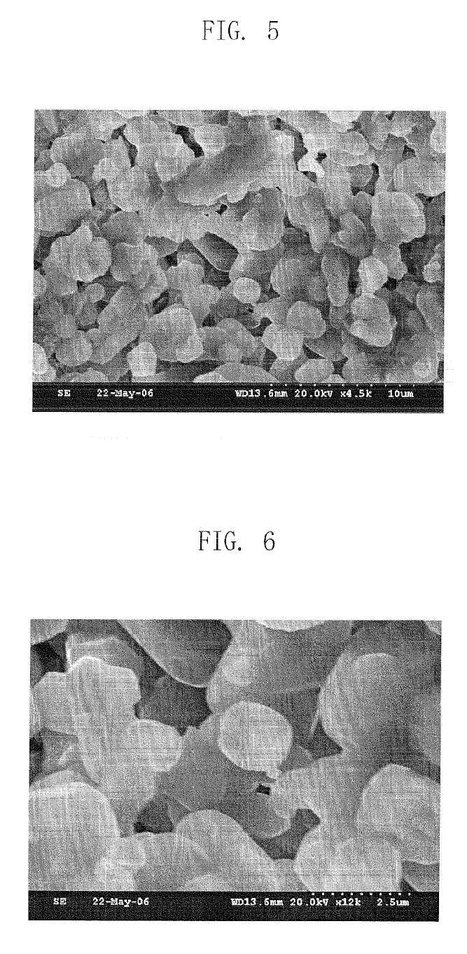

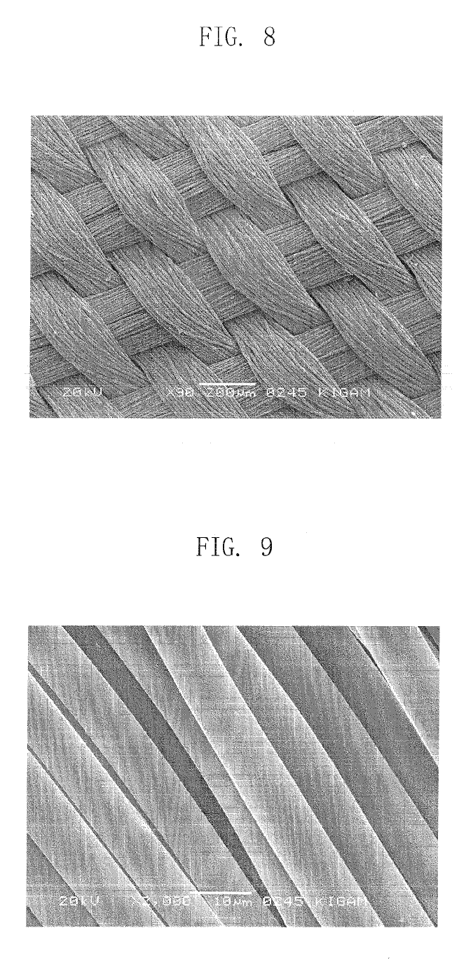

Scanning electron microscope photographs of the ion exchange type lithium adsorbent using the ultra filtration filter, the ceramic filter, and the narrow fabric filter obtained by the embodiments 1 to 6 are shown in FIGS. 1, 2, 5, 6, 8 and 9, respectively. As shown in FIGS. 1, 2, 5, 6, 8 and 9, it will be appreciated that resultant materials obtained by the embodiments 1 to 6 are adsorbent in which the ion exchange type manganese oxide is filled in the ultra filtration filter, the ceramic filter, and the narrow fabric filter, respectively, to maximize an adsorption reaction area and manufacture good adsorbent having adsorption efficiency that is not decreased in comparison with adsorbent powder.

In order to evaluate adsorption efficiency of adsorbent in accordance with the present invention, adsorption efficiency of the ion exchange type lithium adsorbent using the ultra filtration filter, the ceramic filter and the narrow fabric filter obtained by the embodiment 1, 3 and 5, and lithium in powder were compared. As a result of comparison of lithium in artificial seawater specimen (Na 1.07×10⁴ mg/L, Mg 1.3×10³ mg/L, K 0.4×10³ mg/L, Ca 0.4×10³ mg/L, Cl 1.68×10⁴ mg/L, and Li 0.2 mg/L), while adsorption capacity of adsorbent powder is lithium 28.3 mg per adsorbent 1 g, adsorption capacity in the case of using the ultra filtration filter and the ceramic filter according to the embodiments 1 and 3 was lithium 28.1 mg per adsorbent 1 g, and adsorption capacity in the case of using the narrow fabric filter according to the embodiment 5 was lithium 28.3 mg per adsorbent 1 g

As can be clearly determined from the above adsorption capacity measurement result, the ion exchange type lithium adsorbent using a filter in accordance with the present invention shows high adsorption capacity similar to adsorbent powder, provide easy handling, and increase physical and chemical stability, thereby appropriately and effectively using the ion exchange type lithium adsorbent.

As can be seen from the foregoing, the adsorbent in accordance with the present invention is prepared by filling ion exchange type lithium manganese oxide powder in a filter such as an ultra filtration filter, a ceramic filter, a narrow fabric filter, or the like, having good solvent transmissivity, mechanical strength, and chemical resistance, and acid treating the powder to form an ion sieve. As a result, it is possible to facilitate handling, provide excellent adsorption reaction space in comparison with a pre-formed adsorbent, selectively adsorbing an lithium ion only with good efficiency, and readily perform a desorption process for collecting the adsorbed lithium ion.

In addition, since the ion exchange type lithium adsorbent having a filter shape prepared in accordance with the present invention has physical and chemical stability in various environmental aqueous solutions and high selectivity with respect to a lithium ion, it is possible to selectively adsorb lithium only from aqueous solution such as seat water, salt water, lithium battery waste liquid, and so on, in which lithium is dissolved, and effectively use the adsorbent to collect lithium.

What is claimed is:

1. A method for preparing an ion exchange type lithium adsorbent using a filter comprising:
synthesizing precursor powder as lithium manganese oxide having a spinel structure;
filling the precursor powder in the filter; and
acid-treating the filter filled with the precursor powder.

2. The method of claim 1, the synthesizing precursor powder has the following chemical formula 1,
LiₙMn₂₋ₓO₄, wherein 1≦n≦1.33, 0≦n≦0.33, and n≦1+x. [Chemical Formula 1]

3. The method of claim 2, wherein the precursor powder of the chemical formula 1 is lithium manganese oxide having the following chemical formula 2,
Li_{1.33}Mn_{1.67}O₄. [Chemical Formula 2]

4. The method of claim 1, wherein the precursor powder is lithium manganese oxide having the following chemical formula 3,
Li_{1.6}Mn_{1.6}O₄. [Chemical Formula 3]

5. The method of claim 1, wherein the acid treatment is performed in acid solution of 0.3-1.0M three to five times, 22-24 hours each time.

6. The method of claim 1, wherein the filter is at least one selected from the group consisting of an ultra filtration filter, a ceramic filter, and a narrow fabric filter.

7. The method of claim 1, wherein the filter is a ceramic filter.

8. The method of claim 7, wherein the ceramic filter is formed of alumina having a pore size of 1-10 μm.

9. The method of claim 1, wherein the filter is a narrow fabric filter.

10. The method of claim 9, wherein the narrow fabric filter is formed of narrow fabric prepared in plain fabric through a circular weaving machine using polyester warp and woof.

11. The method of claim 10, wherein the narrow fabric filter is formed of narrow fabric having a fabric density 20-25.

12. An ion exchange type lithium adsorbent using a filter formed of ion exchange type manganese oxide powder having a spinel structure filled in the filter.

13. The ion exchange type lithium adsorbent using a filter of claim 12, wherein the ion exchange type manganese oxide powder has the following chemical formula 1a,
HₙMn₂₋ₓO₄, wherein 1≦n≦1.33, 0≦n≦0.33, and n≦1+x, filled therein. [Chemical Formula 1a]

14. The ion exchange type lithium adsorbent using a filter of claim 13, wherein the manganese oxide of the chemical formula 1a is an ion exchange type manganese oxide having a spinel structure and the following chemical formula 2a,
H_{1.33}Mn_{1.67}O₄. [Chemical Formula 2a]

15. The ion exchange type lithium adsorbent using a filter of claim 12, wherein the manganese oxide is an ion exchange type manganese oxide having a spinel structure and the following chemical formula 3a,
H_{1.6}Mn_{1.6}O₄. [Chemical Formula 3a]

16. The ion exchange type lithium adsorbent using a filter of claim 12, wherein the filter is at least one selected from the group consisting of an ultra filtration filter, a ceramic filter, and a narrow fabric filter.

17. The ion exchange type lithium adsorbent using a filter of claim 12, wherein the filter is a ceramic filter.

18. The ion exchange type lithium adsorbent using a filter of claim 17, wherein the ceramic filter is formed of alumina having a pore size of 1-10 μm.

19. The ion exchange type lithium adsorbent using a filter of claim 12, wherein the filter is a narrow fabric filter.

20. The ion exchange type lithium adsorbent using a filter of claim 19, wherein the narrow fabric filter is formed of narrow fabric prepared in plain fabric through a circular weaving machine using polyester warp and woof.

21. The ion exchange type lithium adsorbent using a filter of claim 20, wherein the narrow fabric filter is formed of narrow fabric having a fabric density 20-25.

22. The ion exchange type lithium adsorbent using a filter of claim 13, wherein the ion exchange type manganese oxide of the chemical formula 1a is obtained by acid treating a lithium manganese oxide precursor having the following chemical formula 1,
LiₙMn₂₋ₓO₄, wherein 1≦n≦1.33, 0≦n≦0.33, and n≦1+x. [Chemical Formula 1]

23. The ion exchange type lithium adsorbent using a filter of claim 14, wherein the ion exchange type manganese oxide of the chemical formula 2a is obtained by acid treating a lithium manganese oxide precursor having the following chemical formula 2,
Li_{1.33}Mn_{1.67}O₄. [Chemical Formula 2]

24. The ion exchange type lithium adsorbent using a filter of claim 15, wherein the ion exchange type manganese oxide of the chemical formula 3a is obtained by acid treating a lithium manganese oxide precursor having the following chemical formula 3,
Li_{1.6}Mn_{1.6}O₄. [Chemical Formula 3]
